(19) United States
(12) Patent Application Publication
(10) Pub. No.: US 2013/0041674 A1
(43) Pub. Date: Feb. 14, 2013

(54) Method and Apparatus for Compensating Marketing Personnel

(71) Applicant: James Allison Moore, JR., Indianapolis, IN (US)

(72) Inventor: James Allison Moore, JR., Indianapolis, IN (US)

(21) Appl. No.: 13/206,467

(22) Filed: Aug. 9, 2011

(51) Int. Cl. G06Q 30/00

(52) U.S. Cl. 705/1.1

(57) ABSTRACT

A new new compensation method and apparatus have been developed to make the compensation more fair than any other compensation program available. In the present invention, the recruited sales people are rotated into and out of differing compensation levels on a predetermined time frame. There can be up to four different payment areas or vortexes for payment of the sales people.

### BACKGROUND OF THE INVENTION

### Field of the Invention

There are many methods of compensating people who are in the business of network marketing. Typically, each person earns a percentage of their own sales and of the sales of people who they recruit to also make sales. One person's overall sales and compensation may depend on how good their recruits are and where in their linage of recruits any one person is.

A new compensation method and apparatus have been developed to make the compensation more fair than any other compensation program available. In the present invention, the recruited sales people are rotated into and out of differing compensation levels on a predetermined time frame. There can be up to four different payment areas for payment of the sales people.

### SUMMARY OF THE INVENTION

The present invention is directed to a method of compensating a person for marketing a product or service, the person having associated therewith a plurality of persons divided into a plurality of levels, each of the persons being in a level and being associated with at least two persons in a subsequent level that includes compensating the person a first predetermined amount for each sale of the product or service by a first plurality of persons in a first level, compensating the person a second predetermined amount for each sale of the product or service by a second plurality of persons in the first level, and rotating at least one of the persons in the first plurality of persons in the first level into the second plurality of persons in the first level and rotating at least one of the persons in the second plurality of persons into the first plurality of persons after a predetermined time period.

In some embodiments, the the person is compensated for the sales of at least two persons associated with a person in a higher level, the person in the higher level being associated with at least one of the persons in the second plurality of persons.

In some embodiments, the person is compensated for the first two persons in a second level at the second predetermined amount, the two persons in the second level being associated with one of the persons in the second plurality of persons in the first level, and a third predetermined amount for a third person in the second level and two persons in a third level associated with the third person.

In some embodiments, the he person is compensated a fourth predetermined amount for a fourth person in the second level and two persons in a third level associated with the third person.

In another aspect, the invention is directed to computer system for facilitating payments to a person for marketing a product or service, the person having associated therewith a plurality of persons who also market a product or service, the computer system being adapted for dividing each of the persons in the plurality of persons into a plurality of levels, each of the persons being in a level and being associated with at least one person in a higher level, assigning each of the persons in a first level to one of a first plurality of persons and a second plurality of persons, tracking the sales of the products or services of each of the persons in the first and second pluralities of persons during a predetermined period, determining the amount of payments due to the person based on the sales of the products or services by each of the persons in the first and second pluralities of persons, and moving at least one of the persons in the first plurality of persons from the first plurality of persons into the second plurality of persons and moving one of the persons in the second plurality of persons from the second plurality of persons into the first plurality of persons after the predetermined time period.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description of the present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operations of the invention.

### BRIEF DESCRIPTION OF THE DRAWINGS

FIG. 1 is a schematic representation of the relationship between the marketing person and a plurality of persons in a first level according to the present invention;

FIG. 2 is a schematic representation showing the relationship of the marketing person with different persons for compensation through a number of levels;

FIG. 3 is a schematic representation illustrating the third level of marketing persons and the compensation for the marketing person at a third predetermined rate;

FIG. 4 is a schematic representation illustrating the third level of marketing persons and the compensation for the marketing person at a fourth predetermined rate;

FIG. 5 is a schematic representation illustrating the rotation of persons in the first and second pluralities;

FIG. 6 is a flow chart illustrating one method of compensating marketing person according to one embodiment of the present invention; and

FIG. 7 is a flow chart illustrating the method of compensating the marketing person according to the third predetermined rate.

### DETAILED DESCRIPTION OF THE PREFERRED EMBODIMENTS

Reference will now be made in detail to the present preferred embodiment(s) of the invention, examples of which are illustrated in the accompanying drawings. Whenever possible, the same reference numerals will be used throughout the drawings to refer to the same or like parts.

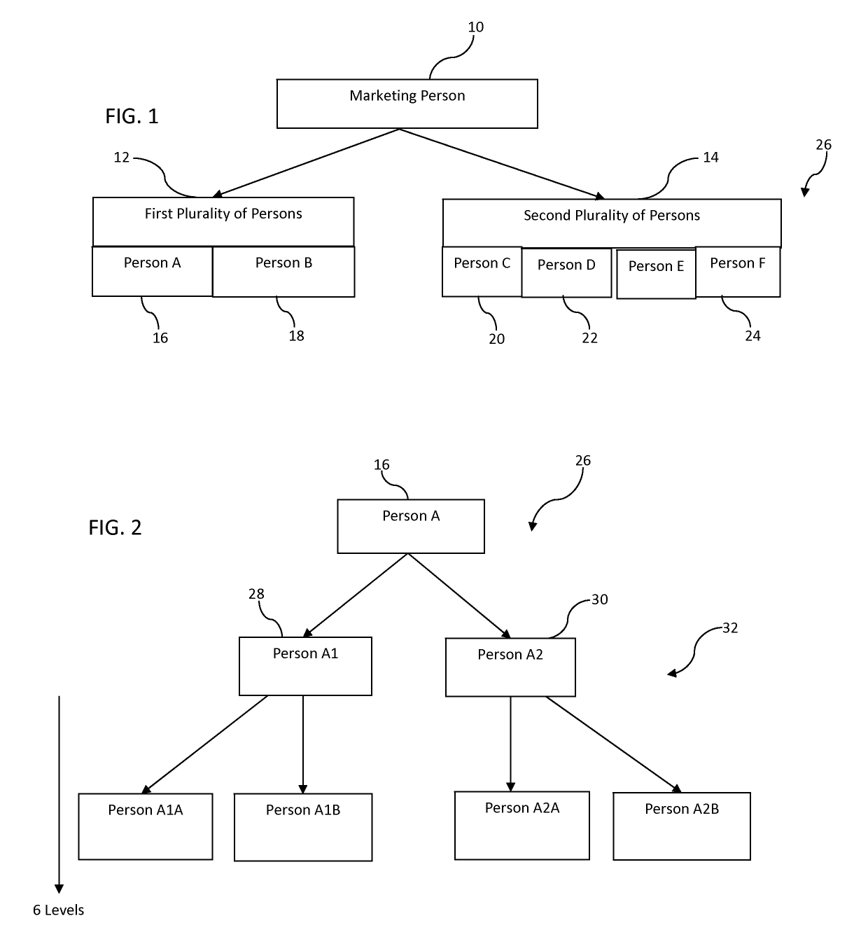

One embodiment of the present invention illustrated in FIG. 1. The marketing person 10 represented in FIG. 1 is a person who has agreed to sell certain products for a company. The marketing person 10 is paid a first predetermined rate for sales that are attributed to the marketing person 10. The marketing person 10 can recruit other persons to also sell products. As illustrated in FIG. 1, the other recruits are divided into plurality of groups, which will be explained in more detail below. When the marketing person 10 recruits the first two persons, those two persons are preferably assigned to a first group-the first plurality of persons 12. If the marketing person 10 recruits more persons, then those additional persons are preferably assigned (for compensation purposes and temporarily, as explained below) to a second plurality of persons 14. However, in one embodiment, if the marketing person 10 recruits persons in excess of a certain number, those excess persons may be assigned to other levels as discussed below. In a preferred embodiment, the first plurality of persons 12 has two persons, Person A 16 and Person B 18 and the second plurality of persons 14 preferably has four persons, which is illustrated in FIG. 1 as Person C 20, Person D 22, through Person F 24. In other embodiments, there may be more or fewer persons in the first and second pluralities of persons 12,14. The first and second pluralities of persons 12,14 are in the first level of people 26.

The compensation for marketing person 10 is based on two factors: the sales by marketing person 10 and the sales by each of the persons recruited by marketing person 10 and the marketing person's recruits. The alignment of the recruited persons under marketing person 10 is generally explained in connection with FIG. 2.

As illustrated in FIG. 2, which illustrates the continued recruiting of other sales and marketing persons by those recruited by marketing person 10, the Person A 16 recruits other marketing persons; in this case, Person A128 and Person A230. It should be noted that Person A1 28 and Person A2 30 are in the second level of people 32. Those persons in second level of people 32 recruit other sales and marketing persons, who then form another level of persons, a third level of persons, and this process and alignment of persons continues onward or downward. This process may continue infinitely, but according to a preferred method, the marketing person 10 is only compensated for sales by the first two persons in each level down to sixth level, which is described in more detail below. It should also be noted that while only two persons are illustrated under the other persons (e.g., Person A and Person B, Persons A1 and A2), each of these persons may recruit as many persons as they can so as to maximize their compensation under the program as well. In a preferred embodiment where there are two persons in the first plurality of persons 12 and there are four persons in the second plurality of persons 14, when the marketing person 10 recruits more than six other sales people, those recruited persons are preferably put under one of the other six persons first and second pluralities of persons 12,14. This allows the marketing person 10 to more quickly fill up the down lines and receive compensation for their sales and purchases. For example, if marketing person 10 has filled the six positions in the first and second pluralities of persons 12,14, then a seventh recruit may fill the position of Person A1 28.

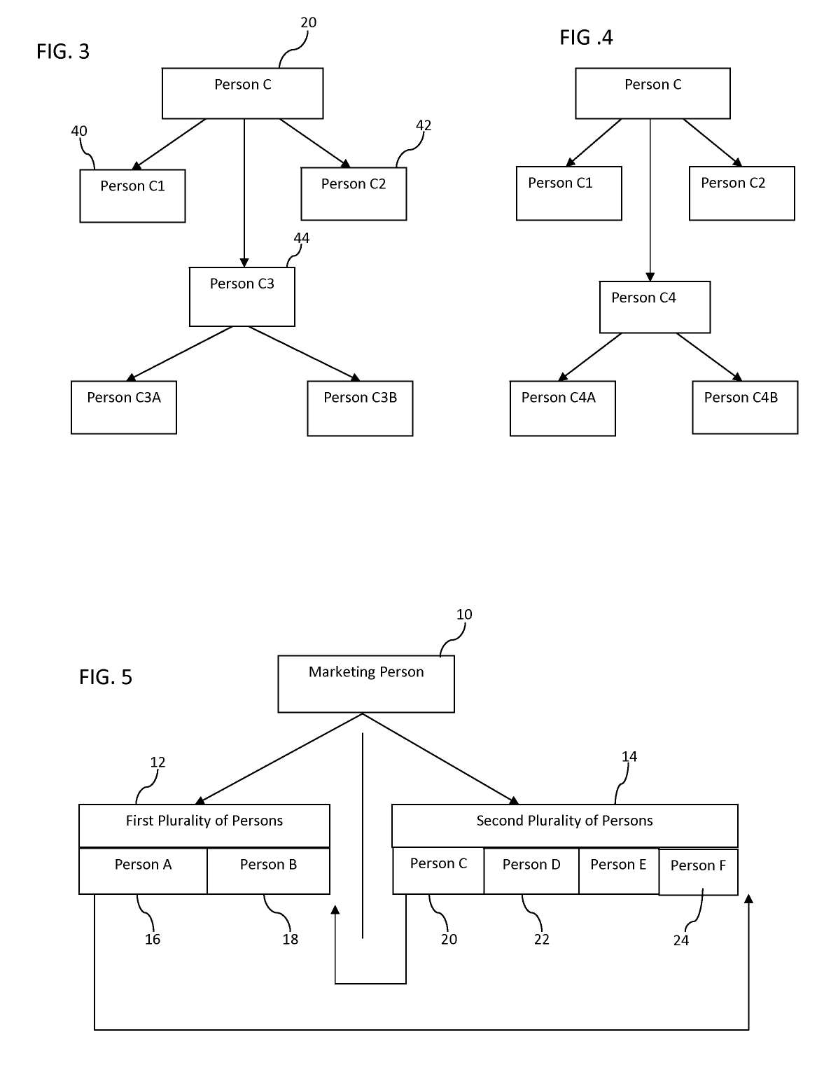

FIG. 3 illustrates a third way that the marketing person 10 can be compensated. In this compensation method, the persons in the second plurality of persons (e.g., Persons C-F), and in the first level, recruit three persons, illustrated as Person C1 40, Person C2 42, and Person C3 44. Only Person C is illustrated in FIG. 3, but the principle applies to the other persons in the second pluralities of persons 14. The marketing person 10 is compensated for the sales of the third person in the second level and each of the first two recruits under that third person and each of the first two recruits by that person. This process follows each of the levels downward to, in the preferred embodiment, an indefinite number of levels.

A fourth way is illustrated in FIG. 4. The fourth way is essentially the same as described in FIG. 3, but instead of sales of the third person in the second level , the compensation is based on the sales of a fourth person, if any, in the second level and the first two of their recruits through an infinite number of levels.

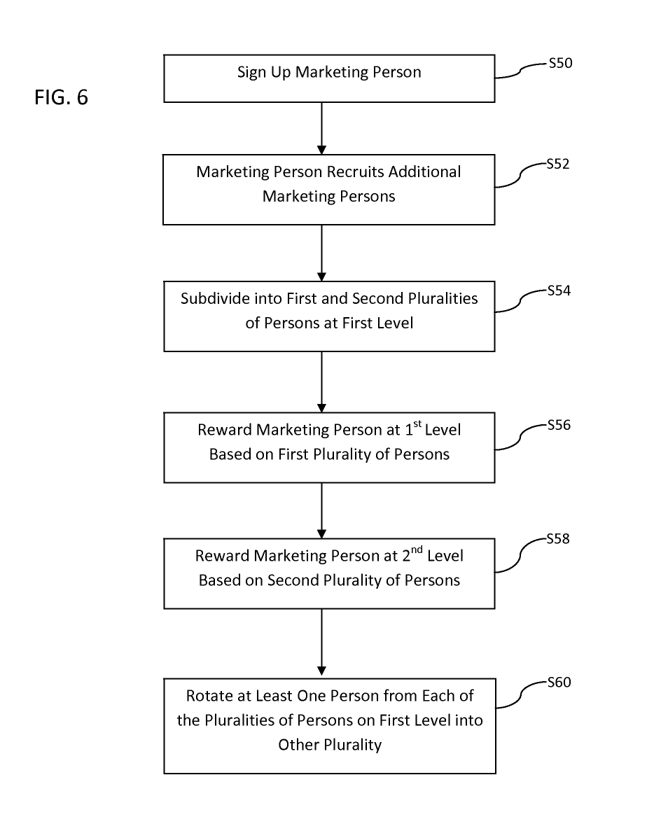

The details of the compensation for the marketing person 10 will now be described in conjunction with FIGS. 5 and 6. At step S50, the marketing person 10 is signed up with the company to sell products and/or services for which the marketing person 10 will make a commission or be compensated. The marketing person 10 then recruits additional people at step S52 to sell either the same and/or different products and/or services. These additional people are divided into the first and second pluralities of persons 12 and 14 at step S54. See also FIG. 1. As noted above, if more than six persons are recruited, the additional persons can be placed for compensation purposes under a recruited person in one of the other levels. After a predetermined time period, usually weekly, the compensation for the marketing person 10 is determined. The compensation is determined using an apparatus, such as a personal computer or other computing means. The tracking of the sales, the number of people, and the relation of people to one another is data and labor intensive, and is best performed on a computer to ensure that the sales/marketing people are compensated correctly. The marketing person 10 is, in one preferred embodiment, paid a first predetermined amount (preferably ranging from 1 to 5%) of the total sales made by the marketing person 10 and the first predetermined amount on 25% of the total sales of of the persons in first plurality of persons 12. See step S56. At step S58, the marketing person 10 is, in one preferred embodiment, paid a second predetermined amount (typically 35%) on the total sales volume for the persons in the second plurality of person 14 and the first two persons under each of the person in the second plurality of persons 14 and so on through as many levels as there are for the marketing person 10. However, the second predetermined amount may be based on less than the total sales volume and still fall within the scope of the invention.

At the end of the predetermined time period and according to step S60, again usually after a week, at least one person in each of the first plurality of persons 12 is moved to the last position in the second plurality of persons 14 and at least one person in the second plurality of persons 14 is rotated into the first plurality of persons 12. See FIG. 5. It should be noted that all of the persons in deeper levels who are related to the rotated persons are also moved. That is, referring to FIG. 2, that Person A1 28 is always associated with Person A 16 and Person A1A is always associated with Person A1,etc., even after rotation. The rotation or switching the persons from one plurality of persons to the other allows the marketing person 10 to offset any disparities in the production of the persons associated with the marketing person 10 and to make the compensation scheme fair to all involved.

While it was noted above that the first predetermined amount is preferably between 1 and 5%, it may be any amount. Similarly, while the second predetermined amount is preferably 35%, that may also be changed and still fall within the scope of the present invention.

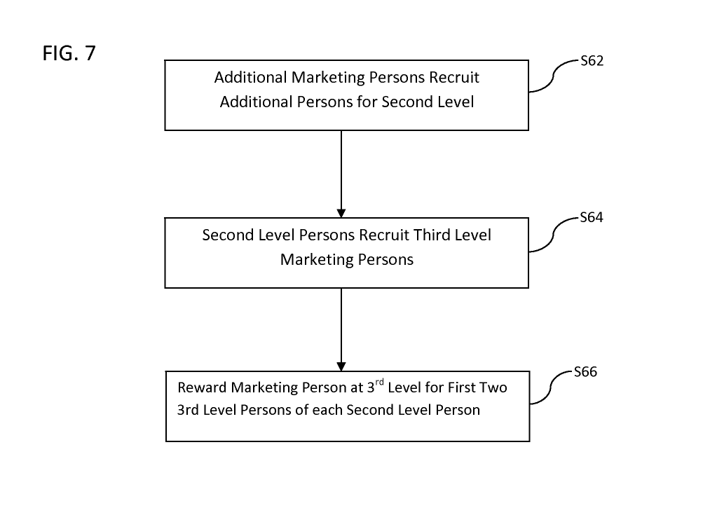

The present invention may also include a third way to compensate the marketing person 10, which will be discussed with reference to FIGS. 3 and 7. As noted above with respect to FIGS. 2 & 3, the persons in the first level also recruit persons for the second level at step S62, who in turn recruit persons in for the third level S64, as so on. Now with regard to FIG. 3, the third person recruited by one of the persons in the second plurality of persons 14, who in this case would be Person C3 44, would also recruit other persons (e.g., Persons C3A and C3B). The marketing person 10 is paid a third predetermined amount for the sales of the third person (Person C3) and their first two recruits. See step S66. In a preferred embodiment, the third predetermined amount is 5% of the sales of each of these persons.

Finally, the marketing person 10 is compensated in a fourth way. The fourth way is same as described above with regard to the third way and FIG. 4. That is, the marketing person 10 receives compensation for the fourth person recruited by each of the persons in the second level 32 of the second plurality of persons 14.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

I claim:

1. A method of compensating a person for marketing a product or service, the person having associated therewith a plurality of persons divided into a plurality of levels, each of the plurality of persons being in a level and being associated with at least two persons in a subsequent level comprising the steps of:
compensating the person a first predetermined amount for each sale of the product or service by a first plurality of persons in a first level;
compensating the person a second predetermined amount for each sale of the product or service by a second plurality of persons in the first level; and
rotating at least one of the persons in the first plurality of persons in the first level into the second plurality of persons in the first level and rotating at least one of the persons in the second plurality of persons into the first plurality of persons after a predetermined time period.

2. The method according to claim 1, wherein the second predetermined amount of compensation being greater than the first predetermined amount of compensation.

3. The method according to claim 1, wherein the person is compensated for the sales of persons in at least five levels associated with the persons in the first plurality of persons.

4. The method according to claim 1, wherein the person is compensated for the sales of at least two persons associated with a person in a higher level, the person in the higher level being associated with at least one of the persons in the second plurality of persons.

5. The method according to claim 1, wherein the first plurality of persons in the first level comprises two persons.

6. The method according to claim 1, wherein the second plurality of persons in the first level comprises four persons.

7. The method according to claim 1, wherein the first predetermined amount is based on the number persons recruited by the person.

8. The method according to claim 1, wherein the person is compensated for the first two persons in a second level at the second predetermined amount, the first two persons in the second level being associated with one of the persons in the second plurality of persons in the first level, and a third predetermined amount for a third person in the second level and two persons in a third level associated with the third person.

9. The method according to claim 1, wherein the person is compensated a fourth predetermined amount for a fourth person in the second level and two persons in a third level associated with the third person.

10. A computer system for facilitating payments to a person for marketing a product or service, the person having associated therewith a plurality of persons who also market a product or service, the computer system being adapted for:
dividing each of the persons in the plurality of persons into a plurality of levels, each of the persons being in a level and being associated with at least one person in a higher level;
assigning each of the persons in a first level to one of a first plurality of persons and a second plurality of persons;
tracking the sales of the products or services of each of the persons in the first and second pluralities of persons during a predetermined period;
determining the amount of payments due to the person based on the sales of the products or services by each of the persons in the first and second pluralities of persons; and
moving at least one of the persons in the first plurality of persons from the first plurality of persons into the second plurality of persons and moving one of the persons in the second plurality of persons from the second plurality of persons into the first plurality of persons after the predetermined time period.

11. The computer system for facilitating payments to a person for marketing a product or service according to claim 10, wherein the person is compensated a first predetermined amount for each sale of the product or service by the first plurality of persons in the first level and a second predetermined amount for each sale of the product or service by the second plurality of persons in the first level.

12. The computer system for facilitating payments to a person for marketing a product or service according to claim 11, wherein the second predetermined amount is greater than the first predetermined amount.

13. The computer system for facilitating payments to a person for marketing a product or service according to claim 10, wherein the person is compensated for the sales of at least two persons associated with a person in a higher level, the person in the higher level being associated with at least one of the persons in the first plurality of persons.

14. The computer system for facilitating payments to a person for marketing a product or service according to claim 13, wherein the person is only compensated for the sales of persons in the first six levels.

15. The computer system for facilitating payments to a person for marketing a product or service according to claim 10, wherein the person is compensated for the sales of at least two persons associated with a person in a higher level, the person in the higher level being associated with at least one of the persons in the second plurality of persons.

16. The computer system for facilitating payments to a person for marketing a product or service according to claim 10, wherein the first plurality of persons in the first level comprises two persons.

17. The computer system for facilitating payments to a person for marketing a product or service according to claim 10, wherein the second plurality of persons in the first level comprises four persons.
